(19) United States
(12) Patent Application Publication
(10) Pub. No.: US 2013/0024087 A1
(43) Pub. Date: Jan. 24, 2013

(54) ABNORMAL COMBUSTION DETECTION AND CHARACTERIZATION METHOD FOR INTERNAL-COMBUSTION ENGINES

(71) Applicants: Laurent Duval, Nanterre (FR); Aurelien Schutz, Libourne (FR); Jean-Marc Zaccardi, Rueil-Malmaison (FR)

(72) Inventors: Laurent Duval, Nanterre (FR); Aurelien Schutz, Libourne (FR); Jean-Marc Zaccardi, Rueil-Malmaison (FR)

(21) Appl. No.: 13/547,205

(22) Filed: Jul. 12, 2012

(30) Foreign Application Priority Data
Jul. 21, 2011 (FR) 11/02.275

(51) Int. Cl. F02D 45/00; F23R 3/00

(52) U.S. Cl. 701/102

(57) ABSTRACT

An abnormal combustion detection and characterization method for spark-ignition internal-combustion engines using combustion indicators is disclosed. A multidimensional space having each dimension corresponding to one of the indicators is defined and a closed surface is defined in this space to surround points corresponding to normal combustions and to not surround points corresponding to abnormal combustions. For each combustion of an engine cycle, the combustion of the cycle is represented by a point in this multidimensional space, the position of this point with respect to the surface is determined and the abnormal nature of the combustion is deduced therefrom.

### CROSS REFERENCE TO RELATED APPLICATION

Reference is made to French Application No. 11/02.275, filed on Jul. 21, 2011, which application is incorporated herein by reference in its entirety.

### BACKGROUND OF THE INVENTION

1. Field of the Invention

The present invention relates to control of the combustion phase of an internal-combustion engine and notably relates to a method for detecting an abnormal combustion, of pre-ignition type at low speed and high load, in a combustion chamber of such an engine. It more particularly relates, but not exclusively, to such a method applied to a downsized spark-ignition engine running at very high loads.

2. Description of the Prior Art

Spark-ignition engines afford the advantage of limiting local emissions (HC, CO and NO_{N}) thanks to the excellent match between the operating mode (at richness 1) and their simple and low-cost after-treatment system. Despite this essential advantage, these engines are badly positioned in terms of greenhouse gas emissions because Diesel engines, which they are in competition with, can have 20% less CO₂ emissions on average.

The combination of downsizing and supercharging is one of the solutions that have become increasingly widespread for lowering the consumption of spark-ignition engines. Unfortunately, the conventional combustion mechanism in these engines can be disturbed by abnormal combustions. This type of engine includes at least one cylinder comprising a combustion chamber defined by an inner lateral wall of the cylinder, by the top of the piston that slides in each cylinder and by the cylinder head. Generally, a fuel mixture is contained in this combustion chamber which undergoes a compression stage, then a combustion stage produced by a spark ignition, by a spark plug. These stages are grouped together under the term “combustion phase” in the rest of the description.

It has been observed that this fuel mixture can undergo various combustion types and that these combustion types are the source of different pressure levels, which cause mechanical and/or thermal stresses some of which can seriously damage the engine.

The first combustion type, referred to as conventional combustion or normal combustion, is the result of the propagation of the combustion of a fuel mixture compressed during a prior engine compression stage. This combustion normally propagates in a flame front from the spark generated at the plug which there being no risk of damage to the engine.

Another combustion type is a knocking combustion resulting from an unwanted self-ignition in the combustion chamber. Thus, after the fuel mixture compression stage, the plug is actuated so as to allow ignition of this fuel mixture. Under the effect of the pressure generated by the piston and of the heat released by the fuel mixture combustion start, a sudden and localized self-ignition of part of the compressed fuel mixture occurs before the flame front resulting from the ignition of the fuel mixture by the spark plug comes near. This mechanism, referred to as engine knock, leads to a local pressure and temperature increase and it can generate, in case it occurs repeatedly, destructive effects on the engine and mainly on the piston.

Finally, another combustion type is an abnormal combustion due to a pre-ignition of the fuel mixture before the spark plug initiates ignition of the fuel mixture present in the combustion chamber. This abnormal combustion affects in particular engines that have undergone downsizing. This operation is intended to reduce the size and/or the capacity of the engine while keeping the same power and/or the same torque as conventional engines. Generally, this type of engine is essentially of gasoline type and it is highly supercharged.

It has been observed that this abnormal combustion occurs at high loads and generally at low engine speeds, when timing of the fuel mixture combustion cannot be optimum because of engine knock. Considering the high pressures and the high temperatures reached in the combustion chamber as a result of supercharging, an abnormal combustion start can occur, sporadically or continuously, well before ignition of the fuel mixture by the spark plug. This combustion is characterized by a first flame propagation phase that occurs too soon in relation to that of a conventional combustion. This propagation phase can be interrupted by a self-ignition involving a large part of the fuel mixture present in the combustion chamber, much larger than in the case of engine knock (up to 50%, against 5 to 10% for extreme cases of severe knock).

In cases where this abnormal combustion takes place repeatedly, from engine cycle to engine cycle, and starts from a hot spot of the cylinder for example, it is referred to as “hot surface pre-ignition”. If this combustion occurs suddenly, in a random and sporadic way, it is referred to as “rumble”.

The latter abnormal combustion leads to very high pressure levels (120 to 250 bars) and to a thermal transfer increase that may cause partial or total destruction of the moving elements of the engine, such as the piston or the piston rod. This pre-ignition type is currently a real limit to spark-ignition engine downsizing. It is a very complex phenomenon that can have many origins. Several hypotheses have been mentioned in the literature to explain its appearance, but so far none has been clearly validated. It appears that several of the potential causes occur simultaneously and interact with one another. This interaction, the violence of the phenomenon and its stochastic character make it extremely difficult to analyze. Furthermore, all the various studies on the subject come up against the problem of proper identification of these abnormal combustions. It is in fact difficult to say if an engine is more sensitive than another to pre-ignition as long as a decision is not reached on the nature of each of the combustions within a given sample.

A method allowing detection and characterizing in number and intensity the abnormal combustions is therefore absolutely essential because it precisely allows establishing this hierarchy and identifying the tracks that will enable improvement of the design and the adjustments of engines. This operation is particularly interesting during test bench engine developments.

The general methodology for dealing with these abnormal combustions is diagrammatically shown in FIG. 1, with first a prevention phase (PP) for limiting to the maximum phenomenon appearance risks, then a detection phase (PD) when prevention is not sufficient to avoid the phenomenon, to determine whether it is pertinent to intervene in the very cycle where pre-ignition was detected by means of a corrective phase (PC).

The detection phase comprises a signal acquisition phase, then a signal processing phase allowing detection of the appearance of pre-ignition at high load in order to characterize and to quantify it.

EP Patent application 1,828,737 describes a method for detecting the appearance of pre-ignition at high load, of rumble type. This method is based on the measurement of a signal relative to the progress of the combustion and a comparison with a threshold signal. The presence of an abnormal combustion of the rumble type in the combustion chamber is detected when the amplitude of the signal significantly exceeds that of the threshold signal. According to this method, the threshold signal corresponds to the amplitude of the signal produced upon knocking combustion or normal (conventional) combustion.

However, according to this method, the detection which is achieved does not allow acting during the detection cycle itself. The corrective actions on this type of pre-ignition can only be carried out after such a phenomenon has occurred, which may seriously harm the engine integrity.

Another method is also described in French Patent 2,897,900. According to this method, action can be taken more rapidly after pre-ignition detection. Action during the same cycle as the phenomenon detection cycle is possible. The threshold signal is therefore first calculated, that is before engine operation, then stored in data charts (maps) of the calculator.

However, the use of engine maps does not allow detection at any time, that is in real time at the start of such a phenomenon. Detection may therefore occur too late. Furthermore, no quantification of the evolution of the phenomenon can be carried out. Thus, the necessity or not of applying a corrective phase is based only on the comparison of two amplitudes at a given time. Now, such a phenomenon may also start, then stop without causing any damage to the engine, and therefore require no corrective phase.

French Patent Application 2,952,678 discloses an abnormal combustion detection method for spark-ignition internal-combustion engines using several combustion indicators. According to this method, several combustion indicators, such as CA10 and MIP, are determined and these indicators are converted to new indicators having lower dispersions than those of the unconverted normal combustion indicators. A parameter characterizing a distribution of N values of these new combustion indicators, acquired over N cycles preceding the cycle in progress, is then determined. The start of an abnormal combustion is thereafter detected by comparing this parameter with a threshold, and the progress of the abnormal combustion detected in the combustion chamber is controlled.

The goal of all these prior methodologies is to quantify the pre-ignition appearance frequency, without providing a good representation of the violence (intensity) of the phenomena which is detected. Cylinder heads can only be dimensioned if the potential pre-ignition frequency and intensity are known.

### SUMMARY OF THE INVENTION

The invention is a method allowing detection in real time of the appearance of an abnormal combustion, to characterize its appearance frequency and its intensity, with the devices and systems commonly used in engines, so as to take steps for prevention of abnormal combustion from appearing in the subsequent engine operating phases, during the same cycle as the detection cycle. The method is based on the definition of a multidimensional space with each dimension corresponding to a combustion indicator and on the definition, in this space, of a closed surface defining normal combustion and abnormal combustion. The position and the distance of a point corresponding to a combustion with respect to this surface allows qualifying the abnormal nature of combustion, as well as the severity of the abnormal nature.

In general terms, the invention relates to a method for controlling the combustion of a spark-ignition internal-combustion engine, wherein at least one signal representative of a state of the combustion is recorded by at least one detector arranged in the engine. The method comprises the following stages:

selecting combustion indicators that can be determined from the signal and defining a multidimensional space in which each dimension corresponds to one of the indicators, and wherein any combustion can be represented by a point;

defining in the space as a closed surface to surround points corresponding to normal combustions and not to surround points corresponding to abnormal combustions;

then, for each combustion of an engine cycle:

representing the combustion of the cycle by a point in the multidimensional space by determining for this combustion the indicators;

determining a position of the point with respect to the surface and determining therefrom an abnormal nature of the combustion;

determining a distance between the point and the surface, and determining therefrom a severity of the abnormal nature of the combustion, and controlling the progress of the detected abnormal combustion as a function of the severity of the abnormal nature.

According to an embodiment, the surface is defined by carrying out the following stages:

selecting an equation comprising at least one parameter defining the surface,

carrying out a set of combustions wherein normal combustions and abnormal combustions are known, and representing the set of combustions in the multidimensional space as a cluster of points;

determining, by a principal component analysis, principal directions of the cluster of points, and determining a dispersion of the points in each principal direction; and

modifying the parameter so that the extension of the surface in each principal direction is equal to the dispersion in this direction.

According to this embodiment, a multiplying coefficient can be defined and applied to each dispersion prior to modifying the parameter. This multiplying coefficient can be selected between 2.4 and 2.6 and preferably is equal to 2.5.

According to the invention, the surface can be updated from a point obtained from a new combustion with the surface possibly being a quadric surface.

Finally, according to an embodiment, the indicators are normalized.

### BRIEF DESCRIPTION OF THE DRAWINGS

Other features and advantages of the invention will be clear from reading the description hereafter, with reference to the accompanying figures wherein:

FIG. 1 shows the general methodology for dealing with abnormal combustions of the pre-ignition type;

FIG. 2 shows an engine using the detection method according to the invention;

FIG. 3 is an example of three-dimensional representation of data calculated on a working point with pre-ignition;

FIG. 4 shows a superposition of normalized data obtained on various working points;

FIG. 5 illustrates an example of identification of the principal directions with zoom being on the right-hand figure wherein the principal axes may not seem to be orthogonal because of the different scales;

FIG. 6 illustrates the determination of the optimum thickness of the normality surface;

FIG. 7 shows an estimation of the envelope of the normal combustions by a quadric surface using the multiplying coefficient 2.5; and

FIG. 8 illustrates the distance to normality of the pre-ignitions (represented by the size of the circles).

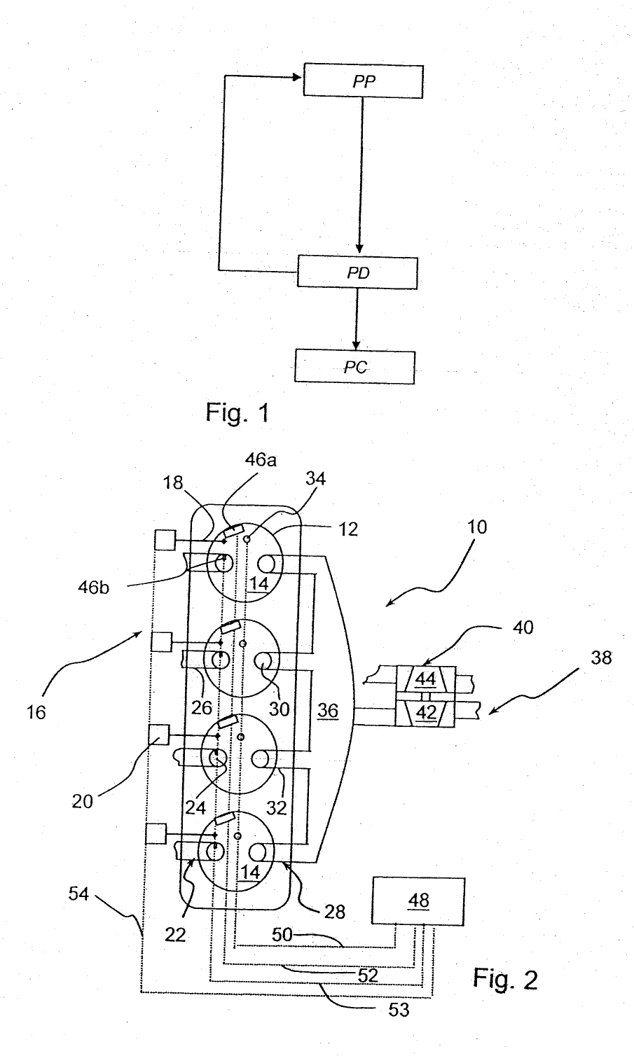

### DETAILED DESCRIPTION OF THE INVENTION

In FIG. 2, a spark-ignition supercharged internal-combustion engine 10, in particular of gasoline type, comprises at least one cylinder 12 with a combustion chamber 14 within which combustion of a mixture of supercharged air and of fuel takes place.

The cylinder comprises at least one means 16 for delivering fuel under pressure, for example in form of a fuel injector 18 controlled by a valve 20, opening into the combustion chamber, at least one air supply means (intake) 22 with a valve 24 associated with an intake pipe 26 ending in a plenum 26b (not shown in the figure), at least one burnt gas exhaust means 28 with a valve 30 and an exhaust pipe 32, and at least one ignition means 34 such as a spark plug that allows generation of one or more sparks enabling the fuel mixture present in the combustion chamber to be ignited.

Pipes 32 of exhaust means 28 of this engine are connected to an exhaust manifold 36, which is connected to an exhaust line 38. A supercharging device 40, a turbocompressor for example, is arranged on this exhaust line and comprises a drive stage 42 with a turbine swept by the exhaust gas circulating in the exhaust line, and a compression stage 44 providing intake air under pressure fed into combustion chambers 14 through intake pipes 26.

The engine comprises means 46a for measuring the cylinder pressure, which is located within cylinder 12 of the engine. These measuring means generally are a pressure detector for generating a signal representative of the change of the pressure in a cylinder.

The engine can also comprise means 46b for measuring the intake pressure, located in plenum 26b. These measuring means generally are an absolute pressure detector, of the piezoelectric type, allowing generation of a signal representative of the change of the intake pressure in the intake plenum.

The engine also comprises a computing and control unit 48, referred to as engine calculator, which is connected by conductors some being bidirectional to the various elements and detectors of the engine to receive the various signals emitted by the detectors, such as the water temperature or the oil temperature, in order to process them and then to control the components of this engine to ensure smooth running thereof.

Thus, in the case of the example shown in FIG. 2, spark plugs 34 are connected by conductors 50 to the engine calculator 48 so as to control the ignition time of the fuel mixture, cylinder pressure detector 46a is connected by a line 52 to the engine calculator to send thereto signals representative of the change of the pressure in the cylinder, and valves 20 controlling injectors 18 are connected by conductors 54 to calculator 48 to control fuel injection in the combustion chambers. Means 46b are also connected by a line 53 to engine calculator 48.

In such an engine, the method according to the invention allows detection of the appearance of a pre-ignition phenomenon at high load (of the rumble type), to characterize or describe its frequency of appearance and intensity, using simultaneous characterization of values of several combustion indicators (CA10, MIP, etc.).

The general methodology for dealing with these abnormal combustions comprises several stages:

the first stage relates to preventive actions designed to limit the maximum risks of pre-ignition appearance;

if this preventive stage is not sufficient, a second stage of physical detection of pre-ignition must be carried out (by a selection of detectors for example);

the next stage of data processing must allow characterizing the pre-ignition; and finally

a last stage of corrective action is carried out in order to determine whether it is desirable to intervene in the cycle where pre-ignition has been detected or in the following cycles.

The invention falls within the scope of the third stage. According to an embodiment, the method comprises the following stages:

recording at least one signal (pressure in the cylinder) representative of the state of the combustion by at least one detector arranged in the engine;

selecting combustion indicators that can be determined from the signal and defining a multidimensional space with each dimension corresponding to one of the indicators, and wherein any combustion can be represented by a point;

defining in the space a closed surface to surround points corresponding to normal combustions and not to surround points corresponding to abnormal combustions; and

then, for each combustion of an engine cycle:

representing the combustion of the cycle in progress by a point in the multidimensional space by determining for this combustion the indicators;

determining the position of the point with respect to the surface and determining therefrom the abnormal nature of the combustion in progress;

determining the distance between the point and the surface, and determining therefrom the severity of the abnormal nature; and

controlling the progress of the abnormal combustion detected as a function of the severity of the abnormal nature.

At least one signal representative of the state of the combustion is recorded by a detector arranged in the engine. According to an embodiment, the cylinder pressure is selected. The cylinder pressure is measured using cylinder pressure measuring means 46a. Providing cylinders with pressure measuring devices is becoming increasingly common on vehicles.

The invention allows use of other measurements than the cylinder pressure, such as the instantaneous torque, the instantaneous engine speed, the vibration level (accelerometric detectors), ionization signal, etc.

A preliminary stage (1 and 2 hereafter) is then carried out prior to real-time detection of an abnormal combustion.

1—Selecting Combustion Indicators and Defining a Multidimensional Space

In this stage, combustion indicators that can be determined from the measured signal are selected, and a multidimensional space in which each dimension corresponds to one of the indicators and any combustion can be represented by a point is defined.

According to an embodiment, CA10 is selected. CA10 represents the crank angle position where only 10% of the feed delivered has been consumed. It is therefore very well suited to highlight an anomaly occurring at combustion start such as pre-ignition.

However, simple pre-ignition identification is not sufficient since the goal that is sought is also to characterize the dangerousness of these abnormal combustions. It is therefore necessary to also select variables that explicitly represent the intensity of pre-ignitions.

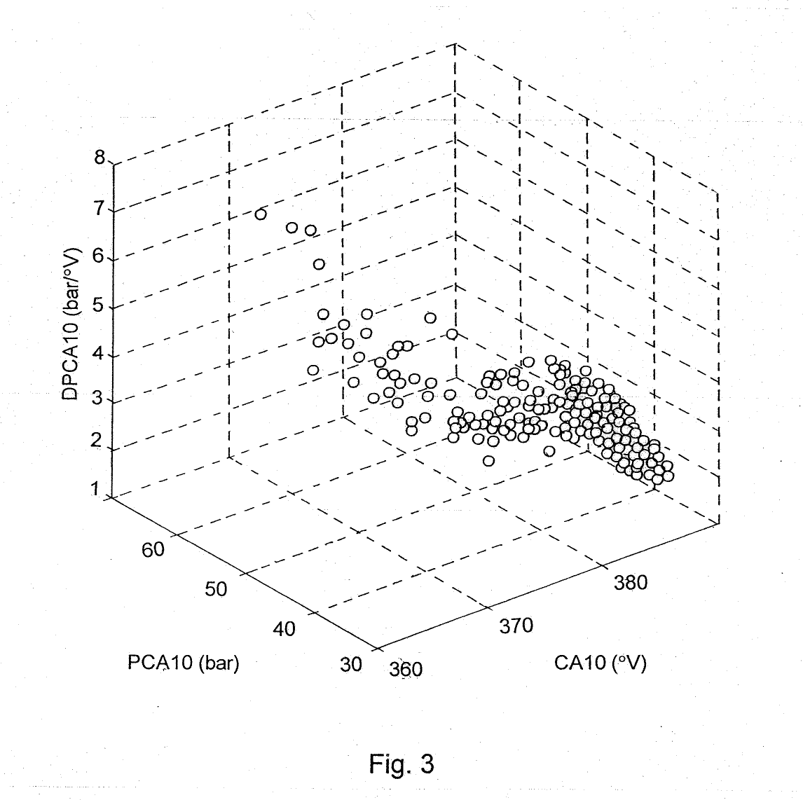

FIG. 3 shows an example of a three-dimensional representation of data calculated at a working point with pre-ignition. In addition to CA10, the pressure (PCA10) and pressure derivative (DPCA10) values at CA10 have been selected. Intuitively, it is understood that the values taken by the pressure and the pressure derivative at CA10 are determining factors for the values they will take later during the cycle, in particular for their maximum values (in other words, there is a strong chance that a combustion that starts off strong continues and ends strong as well).

The invention can also use other combustion indicators:

from the cylinder pressure: MIP, maximum cylinder pressure, crank angle at maximum pressure, CAxx, maximum energy release,

from the instantaneous torque: maximum torque, maximum torque derivative,

from the instantaneous engine speed: maximum speed, maximum acceleration, and

the volume of the combustion chamber, or the volume gradient at certain times (at CA10 for example).

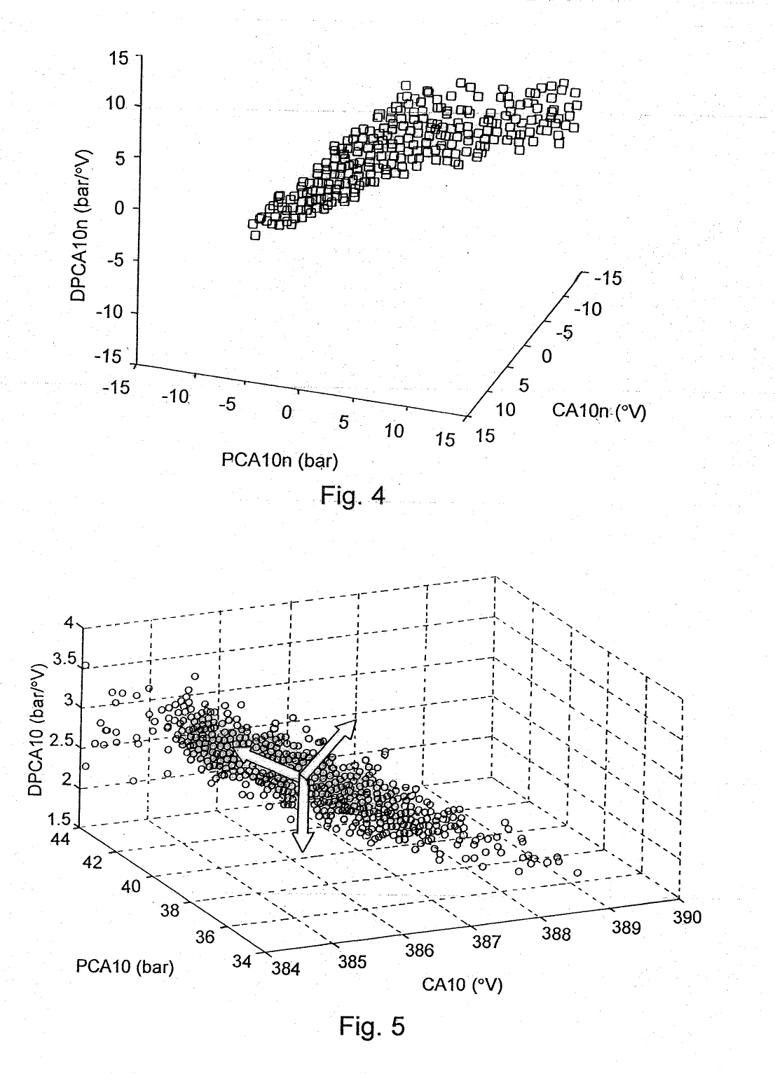

Several tests have been carried out for three-dimensional data representations as in FIG. 3 at different working points, but also with different engines and with different fuels. Systematically, these tests have highlighted correlations between the different variables and normalization of the data has allowed showing that these trends are repeatable. FIG. 4 shows a superposition of normalized data (CA10n, PCA10n, DPCA10n) obtained with various working points. Normal combustions occupy a rather compact area of space and form a condensed data cluster whereas pre-ignitions tend to leave this cluster (just like late combustion, but to a lesser extent).

2—Defining a Closed Surface Containing the Normal Combustions

One goal of the invention is to define the normal combustions to make later extraction of information easier on abnormal combustions in terms of distance from normality.

A closed surface is therefore defined in the multidimensional space to surround points corresponding to normal combustions and not to surround points corresponding to abnormal combustions.

A first set of points corresponding to normal engine combustions and a second set of points corresponding to abnormal engine combustions can thus be used. These sets are represented in the multidimensional space, and a surface surrounding the points corresponding to the first set and avoiding the points of the second set is adjusted.

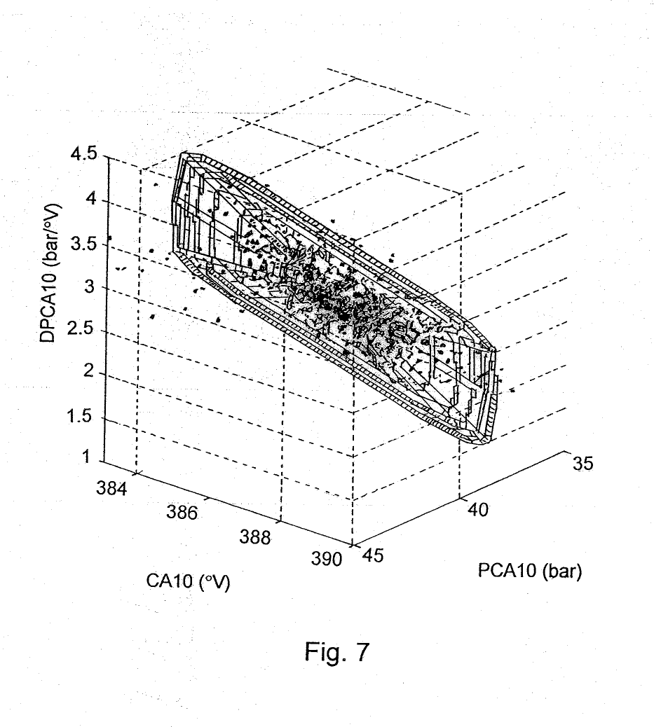

An implementation example where definition is performed in two stages is given hereafter:
i. by identifying first the principal directions present in the data set (the directions are represented by white arrows in FIG. 5);
ii. then by determining a modelling of the normal combustions (FIG. 7).

Each combustion is represented in the multidimensional space as a representation in the form of a point whose coordinates are the values of the indicators calculated in the previous stage. After several cycles, the combustions form a cluster of points in this representation space.

First the principal directions of this cluster of points are determined, that is the directions in which the cluster extends or, in other words, the directions in which dispersion is maximal. According to an example, identification of the principal directions is performed in a robust manner via a principal component analysis (PCA) algorithm. Other algorithms can however be used.

FIG. 5 illustrates an example of identification of principal directions: the principal axes are represented by white arrows which may not appear to be orthogonal because of the different scales.

An envelope (surface) is then constructed around the points corresponding to normal combustions. It is essential to correctly determine this optimum surface that should be neither too large (with the risk of including pre-ignitions), nor too small (with the risk of over-estimating the number of pre-ignitions by considering some normal combustions to be abnormal). To construct this envelope, an envelope shape is selected, then adjusted to the cluster of points along the principal directions of the cluster.

According to an example, the first three principal directions are calculated and an envelope of a quadric type is selected (other types of surface could also be used). A quadric, or quadratic surface, is a surface of the three-dimensional Euclidian space, locus of the points satisfying a Cartesian equation of the second degree. By way of example, the ellipsoid, the hyperboloid, the elliptic paraboloid, the hyperbolic paraboloid, the cylinder (elliptic, hyperbolic or parabolic) are second degree equations.

The parameters of the quadric surface are then adjusted to be centered on the center of the cluster.

In the case of an ellipsoid, the equation is:

$$\frac{{x}^{2}}{{a}^{2}} + \frac{{y}^{2}}{{b}^{2}} + \frac{{z}^{2}}{{c}^{2}} - 1 = 0$$

x, y and z represent the three principal directions forming an orthonormal frame whose center is the center of the cluster of points; and
a, b and c are the parameters of the quadric surface to be adjusted.

The dispersion (for example the standard deviation) of the data is then estimated in each principal direction. This estimation can be advantageously performed after the PCA, that is simultaneously with the determination of principal directions. The dispersion in each principal direction x, y and z defines the extension of the quadric surface. Parameters a, b and c are so selected that the extension of the quadric surface in direction x (respectively y and z) is equal to the dispersion in direction x (respectively y and z).

According to an embodiment, a multiplying coefficient is calculated for the calculated dispersions. The progressive increase of this multiplying coefficient allows increasing the size of the surface surrounding the normal combustions. Thus, according to the example of a quadric surface of an ellipsoid type, parameters a, b and c are so selected that the extension of the quadric surface in direction x (respectively y and z) is equal to the dispersion in direction x (respectively y and z), multiplied by a multiplying coefficient.

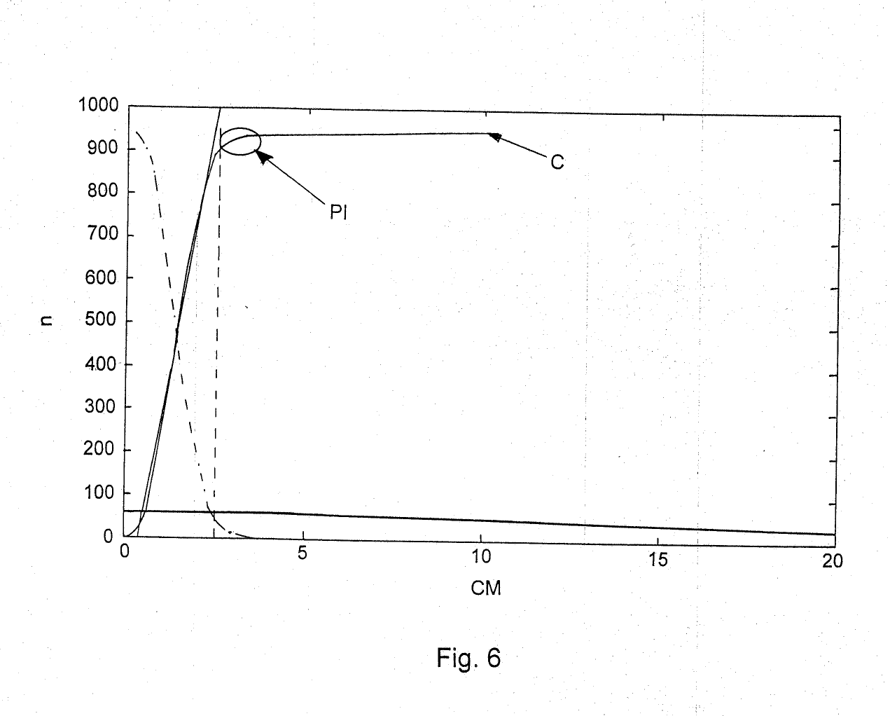

Using a synthetic data set wherein the normal combustions and the combustions with pre-ignition are known allows these multiplying coefficients to be defined. The observations made are illustrated in FIG. 6. The goal is to determine the inflexion (PI) of curve (C) representing the number of points (n) contained in the normality surface, as a function of multiplying coefficient (CM). Indeed, this inflexion corresponds to the time when, despite the size increase of the normality surface, fewer and fewer points enter this surface. The separation between normal combustions and abnormal combustions, much more dispersed, and which therefore require greater multiplying coefficients to be included in the normality surface, is thus reached. In this figure, a multiplying coefficient of 2.5 allows inclusion all the normal combustions. The same procedure applied to nearly 600 data sets generated manually has led to the same result with a value around 2.5 (between 2.4 and 2.6).

FIG. 7 shows an estimation of the normal combustions envelope by a quadric surface using a multiplying coefficient of 2.5.

This surface defined before the detection phase at each cycle of an abnormal combustion can be refined at each cycle by integrating into the cluster the points from the combustions of the cycles preceding the cycle in progress.

Once these preliminary stages (definition of a multidimensional space and of a reference surface) carried out, it is possible to detect, from the signal, an abnormal combustion at each engine cycle.

3—Identifying and Qualifying Abnormal Combustions

During each cycle, the combustion indicators are calculated from the signal and for each combustion. The following stages are then carried out:

representing the combustion of the cycle in progress by a point in the multidimensional space by determining the indicators for this combustion;

determining the position of the point with respect to the surface and deducing therefrom the abnormal nature of the combustion in progress; and

determining the distance between the point and the surface, and deducing therefrom the severity of the abnormal nature.

A method for calculating the distance from a point to an ellipsoid is for example described in the following document: David Eberly, 2011, “Distance from a Point to an Ellipse, an Ellipsoid or a Hyperellipsoid”, Geometric Tools, LLC. In the case of a quadric surface of degree dg, a calculation mode calculates distance d1 from the point to the ellipsoid with the same parameters a, b, c, which gives a good practical approximation of the precise distance. Another possible type of calculation determines the radial line that connects the center of the quadric surface to the point considered, then in calculating the smallest “radial” distance d2 between the point considered and the two intersections (the radial line generally intersects the surface at two points: one close, the other further away (on the other side of the center); it is advisable to take the distance to the closer point) between the quadric surface and the radial line, and in considering the smaller one of the two distances d1 and d2. The distance can thus be slightly over-estimated, which preserves the preventive aspect of the detection provided.

This distance is an indicator of the combustion at each cycle. If the distance indicates that the point characterizing the combustion is outside the cluster, this indicates pre-ignition, and the greater this distance, the greater the intensity of the phenomenon.

Taking simultaneously into account several variables thus allows construction through this distance a “combined” criterion (even if these different variables should be partly correlated).

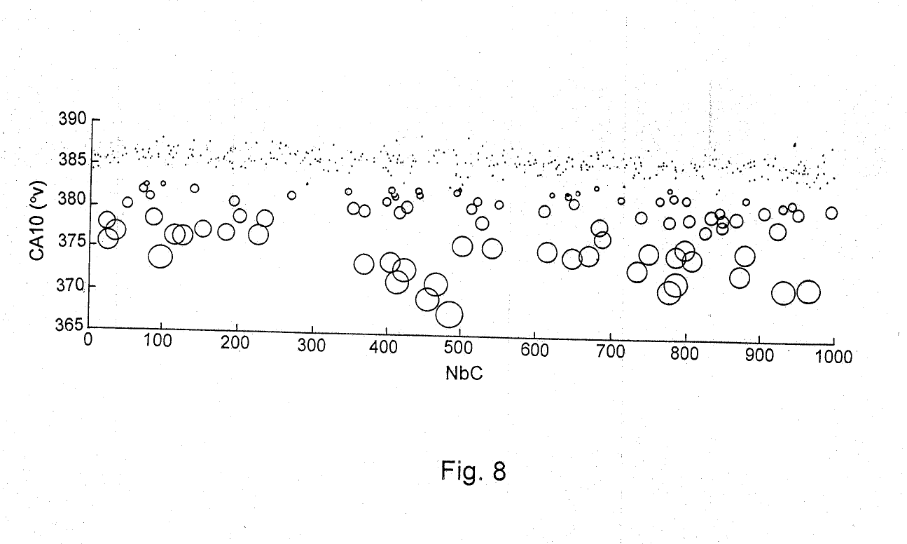

FIG. 8 illustrates this distance by the size of the circles used to represent the various cycles. This figure shows CA10 as a function of cycle NbC. An expected result is thus obtained, that is the earlier a pre-ignition occurs in the cycle (low CA10), the more likely it is to be intense (large-size circle).

However, the method according to the invention allows a better classification of these different pre-ignitions because the distance to normality does not only depend on CA10, but also on several combined variables. In other words, the processing procedure allows association with cycles having similar CA10 values of circles of different sizes, that is different intensities. The two examples at the bottom of FIG. 8 illustrate this phenomenon with the 650 and 671 cycles selected at iso CA10 (around 374 CAD). It is important to underline here that the distances are different although the CA10 values are equivalent.

It should be noted that the method has several degrees of freedom:

the number of variables used,

the principal directions identification method,

the normal combustion modelling method and type, and

the method of calculating the distance from a point to the modelled surface.

Another advantage of the methodology is that, as can be seen in the upper part of FIG. 8, the late combustions also stand out because of their distance to normality, also abnormally great. This methodology can thus also be used for characterizing late combustions and combustion misfires. “Late combustions” are understood to be combustions properly initiated by the spark plug but progressing slowly, thus leading to an efficiency loss. “Combustion misfires” are understood to be combustions that are not initiated at all by the spark plug (due to default richness for example). In terms of cylinder pressure, a simple compression/expansion is observed (or, at best, only a very weak combustion).

These two combustion types involve no danger, unlike pre-ignition. However, it is nevertheless of interest to detect them because they mean poor efficiency or high emission levels as a result of combustion misfires.

4—Controlling Abnormal Combustion

Finally, the progress of the abnormal combustion which is detected is controlled as a function of the severity of the abnormal nature thereof.

By means of the position with respect to the surface, the engine calculator can detect the start of an abnormal combustion of the “pre-ignition” type in the combustion chamber and based on the distance to the surface, it can detect the severity of this abnormal combustion.

In case of abnormal combustion, if the severity thereof is established, this calculator then launches the actions required for control of this combustion in order to avoid continuation of such a combustion.

What is referred to as abnormal combustion control is not only the possibility of controlling the progress of this combustion in order to avoid sudden destructive pressure increases, but also of completely stopping such a combustion, through smothering for example.

This combustion control is preferably carried out by fuel re-injection at a predetermined crank angle through injectors 18. More precisely, the calculator controls valves 20 in such a way that the injector of the cylinder concerned allows an amount of fuel in liquid form to be fed into the combustion chamber. The amount of fuel re-injected depends on the composition of the engine and it can range between 10% and 200% of the amount of fuel initially fed into this combustion chamber. The re-injected fuel is therefore used to counter the flame that starts spreading in case of abnormal combustion. This re-injection allows to either blowing out this flame or to smother it by increasing the richness of the fuel mixture. Furthermore, the fuel injected in liquid form uses the heat present around this flame to vaporize the injected fuel and the temperature conditions around the flame decrease, thus retarding combustion of the fuel mixture and notably its auto-ignition.

After this fuel injection, the pressure in the cylinder increases, but less suddenly. This pressure thereafter decreases and reaches a level compatible with the pressure level of a conventional combustion.

This mechanism prohibits any development of an abnormal combustion with a high combustion rate and high pressures. Of course, the means designed to control abnormal combustion are used at each cycle during which such a combustion is detected by the calculator.

The actions of the method as described above can be combined with other, slower actions, such as throttle closure, to prevent the pressure conditions in the combustion chamber from promoting an abnormal combustion in the next cycles. Selection of the action depends on the severity of the abnormal nature of the combustion.

1-7. (canceled)

8. A method for controlling combustion of a spark-ignition internal-combustion engine, wherein at least one signal representative of a state of the combustion is recorded by at least one detector in the engine, comprising:
selecting combustion indicators that can be determined from the at least one signal and defining a multidimensional space in which each dimension corresponds to one of the indicators and any combustion can be represented by a point in the space;
defining in the space a closed surface surrounding the points corresponding to normal combustions and which does not surround points corresponding to abnormal combustions; and
then, for each combustion of an engine cycle representing the combustion of the cycle by a point in the multidimensional space by determining for the combustion the indicators, determining a position of the point with respect to the surface and determining therefrom an abnormal nature of the combustion, determining a distance between the point and the surface, and determining therefrom a severity of the abnormal nature of the combustion, and controlling progress of the abnormal combustion as a function of the severity of the abnormal nature of the combustion.

9. A method as claimed in claim 8, wherein:
the surface is defined by selecting an equation defining the surface with the equation comprising at least one parameter, carrying out a set of combustions wherein normal combustions and abnormal combustions are known and representing the set of combustions in the multidimensional space to form a cluster of points, determining, by a principal component analysis, principal directions of the cluster of points and determining a dispersion of the points in each principal direction, and modifying the at least one parameter so that the extension of the surface in each principal direction is equal to the dispersion in the principal direction.

10. A method as claimed in claim 9, wherein:
a multiplying coefficient is defined that is applied to each dispersion prior to modifying the parameter.

11. A method as claimed in claim 10, wherein:
the multiplying coefficient is between 2.4 and 2.6.

12. A method as claimed in claim 11, wherein:
the multiplying coefficient is 2.5.

13. A method as claimed in claim 8, wherein:
the surface is updated from a point obtained from a new combustion.

14. A method as claimed in claim 9, herein:
the surface is updated from a point obtained from a new combustion.

15. A method as claimed in claim 10, wherein:
the surface is updated from a point obtained from a new combustion.

16. A method as claimed in claim 11, wherein:
the surface is updated from a point obtained from a new combustion.

17. A method as claimed in claim 12, wherein:
the surface is updated from a point obtained from a new combustion.

18. A method as claimed in claim 8, wherein:
a quadric surface is selected.

19. A method as claimed in claim 9, wherein:
a quadric surface is selected.

20. A method as claimed in claim 10, wherein:
a quadric surface is selected.

21. A method as claimed in claim 11, wherein:
a quadric surface is selected.

22. A method as claimed in claim 12, wherein:
a quadric surface is selected.

23. A method as claimed in claim 13, wherein:
a quadric surface is selected.

24. A method as claimed in claim 14, wherein:
a quadric surface is selected.

25. A method as claimed in claim 15, wherein:
a quadric surface is selected.

26. A method as claimed in claim 16, wherein:
a quadric surface is selected.

27. A method as claimed in claim 17, wherein:
a quadric surface is selected.

28. A method as claimed in claim 8, wherein the indicators are normalized.

29. A method as claimed in claim 9, wherein:
the indicators are normalized.

30. A method as claimed in claim 10, wherein:
the indicators are normalized.

31. A method as claimed in claim 11, wherein:
the indicators are normalized.

32. A method as claimed in claim 12, wherein:
the indicators are normalized.

33. A method as claimed in claim 13, wherein:
the indicators are normalized.

34. A method as claimed in claim 14, wherein:
the indicators are normalized.

35. A method as claimed in claim 15, wherein:
the indicators are normalized.

36. A method as claimed in claim 16, wherein:
the indicators are normalized.

37. A method as claimed in claim 17, wherein:
the indicators are normalized.

38. A method as claimed in claim 18, wherein:
the indicators are normalized.

39. A method as claimed in claim 19, wherein:
the indicators are normalized.

40. A method as claimed in claim 20, wherein:
the indicators are normalized.

41. A method as claimed in claim 21, wherein:
the indicators are normalized.

42. A method as claimed in claim 22, wherein:
the indicators are normalized.

42. A method as claimed in claim 23, wherein:
the indicators are normalized.

44. A method as claimed in claim 24, wherein:
the indicators are normalized.

45. A method as claimed in claim 25, wherein:
the indicators are normalized.

46. A method as claimed in claim 26, wherein:
the indicators are normalized.

47. A method as claimed in claim 27, wherein:
the indicators are normalized.

48. A method as claimed in claim 28, wherein:
the indicators are normalized.
